(19) United States
(12) Patent Application Publication
(10) Pub. No.: US 2012/0119860 A1
(43) Pub. Date: May 17, 2012

(54) MAGNETIC BODY AND A PROCESS FOR THE MANUFACTURE THEREOF

(75) Inventors: Wei Zhao, Singapore (SG); Zhisan Han, Singapore (SG)

(73) Assignee: Magnequench International, Inc., Pendleton, IN (US)

(21) Appl. No.: 13/384,279

(22) PCT Filed: Jul. 16, 2010
(86) PCT No.: PCT/SG2010/000270

§ 371 Date: Jan. 16, 2012

(30) Foreign Application Priority Data
Jul. 16, 2009 (GB) 0912349.8

(51) Int. Cl. H01F 1/053; H01F 7/02

(52) U.S. Cl. 335/302

(57) ABSTRACT

There is disclosed a magnetic body comprising an agglomeration of bonded rare earth magnetic particles characterized in that said magnetic body exhibits a maximum energy product loss (ΔBHmax) of 12% or less as measured by ASTM 977/977M when subjected to a temperature of 180° C. for 1000 hours and a process for the manufacture of the same.

### TECHNICAL FIELD

The present invention relates to a bonded rare earth magnetic body and a process for the manufacture of the same.

### BACKGROUND

Rare earth element-containing compounds have been used to manufacture permanent magnets by shaping rare-earth metal-based magnetic material particles into a predetermined shape. The rare-earth metal-based magnetic material particles are aggregated by a polymer or the like, which acts as a binder. Such polymer-bonded magnets have distinctive advantages over sintered magnets, such as their flexibility to be shaped into various complex shapes within a tight tolerance in a one-step molding processes; this allows a reduction in production cost.

Additionally, a number of polymer binders that meet process and application requirements are known. Hence, the bonded magnets can be manufactured from a wide range of raw materials. However, there are problems associated with the durability of these rare-earth polymer-bonded magnets.

The maximum operating temperature for polymer-bonded magnets is remarkably lower than that for sintered magnets due to two main factors. Firstly, the degradation and softening temperature of polymer-bonded magnets is much lower than the curie temperature of permanent magnetic materials. Secondly, these magnetic particles are susceptible to oxidation and this susceptibility substantially increases with increasing temperature during the bonded magnets working life. While binders with good temperature stability are available, few have barrier properties good enough to withstand oxidation at high temperatures. This susceptibility to oxidation lowers the useful shelf-life of the magnets.

The rapid oxidation of the magnet in air eventually results in a dramatic decrease in the magnetic properties of the magnetic particles and hence of the magnetic body. Oxidation may proceed abruptly even during the course of magnet formation, thereby causing safety concerns in the manufacturing process. These problems need to be addressed for such rare-earth based polymer-bonded magnets to be commercially and industrially viable.

To overcome the oxidation problem, fabrication of the magnets may take place in an inert or non-oxidizing environment or be subjected to pre-compaction heat treatment with certain organosilane coupling agents that prevent interaction of the particles with air. While oxidation may be prevented to some extent, a complete prevention of oxidation within the magnet is challenging without encountering further problems such as decrease in productivity and increase in production cost. Moreover, the high processing temperatures of subsequent drying steps may render the coats unstable and ineffective.

Given the disadvantages of the aforementioned conventional passivating methods, there is a need to provide a passivating technique which, when applied to the manufacture of rare earth metal-based bonded magnets, provides effective resistance against oxidation and which overcomes, or at least ameliorates, the disadvantages described above.

There is also a need to provide for a bonded rare earth magnetic body that overcomes, or at least ameliorates, the disadvantages described above.

### SUMMARY

According to a first aspect, there is provided a magnetic body comprising an agglomeration of bonded rare earth magnetic particles characterized in that said magnetic body exhibits a maximum energy product loss (ΔBHmax) of 12% or less as measured by ASTM 977/977M when subjected to a temperature of 180° C. for 1000 hours.

Advantageously, at least 70% of the total surface area of the magnetic particles in the bonded rare earth magnetic body is substantially inert to oxidation. Hence, the magnetic body may not suffer substantially from oxidation even at high temperatures.

Advantageously, the bonded rare earth magnetic body may be substantially protected from oxidative effects and hence, may be able to retain the magnetic properties for a longer period of time.

According to a second aspect, there is provided a bonded rare earth magnetic body comprising an agglomeration of bonded rare earth magnetic particles characterized in that said magnetic body exhibits lower maximum energy product loss (ΔBHmax) relative to a bonded magnetic body formed of particles coated with anti-oxidant prior to compact formation of said magnetic body.

Hence, the extent of loss of magnetic properties is lesser in the disclosed magnetic body which has been passivated during or after compaction as compared to a magnetic body which has been passivated before compaction.

According to a third aspect, there is provided a process for the manufacture of a bonded rare earth magnetic body comprising the steps of

(a) compacting rare earth magnetic material particles to form said magnetic body; and

(b) contacting a mobile phase comprising an anti-oxidant thereof through said magnetic body during or after said compacting step.

Advantageously, the disclosed process substantially reduces the susceptibility of the rare earth magnetic body to oxidation under atmospheric as well as humid conditions by forming a protective layer over the surfaces of the magnetic material particles that make up the magnetic body. The formation of the protective layer may occur during or after compaction of the magnetic material particles. This may enable the protective layer to coat freshly created surfaces of the magnetic material particles that occur when the magnetic material particles fragment during compaction. Hence, the protective layer may be present on the fresh surfaces and may result in substantially complete coverage of the existing and fresh surfaces of the magnetic material particles that are created during compaction.

It is important that the contacting step be undertaken during or after the compacting step. If there is no mobile phase contacting the magnetic body during or after the compaction step and fresh particle breakage occurs during the compaction step, the fresh particles are not exposed to the anti-oxidant coating and hence they are susceptible to oxidation with the subsequent loss in magnetic properties of the particles and hence bonded magnet from which they are formed. The oxidation of the fresh surfaces created during compaction which have not been exposed to the anti-oxidant results in severe degradation of the magnetic properties upon curing and considerable aging loss (i.e. loss in magnetic properties with time) when working at high temperatures.

Accordingly, by contacting a mobile phase through the magnetic body during or after the compacting step, fresh surfaces that have not been exposed to a passivation step such that they are susceptible to oxidation is avoided. For these reasons, there is a new product formed by contacting a mobile phase comprising an anti-oxidant thereof during or after a compacting step in that the surfaces of the particles are resistant to oxidation.

In one embodiment of the process defined above, there is provided the step of providing a sufficient amount of mobile phase relative to said rare earth magnetic material particles to form a bonded rare earth magnetic body, said bonded rare earth magnetic body exhibiting a maximum energy product loss (ΔBHmax) of 12% or less as measured by ASTM 977/977M when subjected to a temperature of 180° C. for 1000 hours.

### Definitions

The following words and terms used herein shall have the meaning indicated:

The terms “passivate”, “passivating”, “passivated” and grammatical variations thereof refer, in the context of this specification, to the anti-oxidant properties of a surface of a magnetic material particle after exposure to an anti-oxidant. That is, the terms refer to the surface properties of a magnetic material particle which exhibit higher resistance to oxidation compared to the surface of a magnetic material particle which has not been exposed to the anti-oxidant.

The term “in-situ passivation” in the context of this specification refers to passivation of the surfaces of the magnetic material particles during formation of the magnet but not after formation of the magnet.

The term “compression molding” in the context of this specification refers to a method of molding in which the magnetic material particles are first placed in an open, heated mold cavity followed by application of pressure and optionally heat until the particles have cured.

The term “compact” or “compaction” in the context of this specification refers to the compression molding, injection molding or extrusion molding process undergone by the magnetic material particles.

The term “bonded magnetic body” in the context of this specification refers to a magnetic body formed by compacting magnetic material particles to a predetermined shape. A binder may be used to aid in the formation of the bonded magnetic body.

The term “mischmetal” refers to mischmetal ore as known in the art and also includes within its scope the oxidized form of mischmetal ore. The specific combination of rare earth metals in the mischmetal ore varies depending on the mine and vein from which the ore was extracted. Mischmetal generally has a composition, based on 100% of weight, of about 30% to about 70% Ce by weight, about 19% to about 56% La by weight, about 2% to about 6% Pr by weight and from about 0.01% to about 20% Nd by weight, and incidental impurities. A mischmetal in “natural form” means a mischmetal ore which is not refined as defined above. The term “mobile phase” refers to a medium that is capable of at least partially contacting a magnetic body during or after compaction of magnetic material particles such that the medium can make contact with fresh surfaces created during the compaction step with the aid of vacuum or compression force or capillary force.

The term “C₁₋₂₀alkyl” refers to a straight chain or branched chain saturated aliphatic hydrocarbon group which has 1 to 20 carbon atoms. In particular, the alkyl group may have 1 to 10 carbon atoms or may have 1 to 4 carbon atoms. The alkyl group may be optionally substituted with a substituent group selected from the group consisting of hydroxy, a halogen (such as F, Br or I), an amino, a nitro, a cyano, an alkoxy, an aryloxy, a thiohydroxy, a thioalkoxy, a thioaryloxy, a sulfinyl, a sulfonyl, a sulfonamide, a phosphonyl, a phosphinyl, a carbonyl, a thiocarbonyl, a thiocarboxy, a C-amido, a N-amido, a C-carboxy, a O-carboxy, and a sulfonamido

The term “C₃₋₁₀cycloalkyl” refers to a monocyclic or fused ring which contains 3 to 7 carbon atoms. For example, the C₃₋₁₀cycloalkyl group may be a cyclopropane, cyclobutane, cyclopentane, cyclopentene, cyclohexane, cyclohexadiene, cycloheptane, cycloheptatriene, or adamantane. The C₃₋₁₀cycloalkyl group may be optionally substituted with one of the substituent groups mentioned above.

The term “C₂₋₂₀alkenyl” group refers to a straight chain or branched chain unsaturated aliphatic hydrocarbon group which has 2 to 20 carbon atoms, and which contains at least one carbon-carbon double bond. The C₂₋₂₀alkenyl group may be optionally substituted with one of the substituent groups mentioned above.

The term “aryl” group refers to an all-carbon unsaturated monocyclic or fused-ring polycyclic (i.e., rings which share adjacent pairs of carbon atoms) groups. For example, the aryl group may be a phenyl, naphthalenyl or anthracenyl. The aryl group may be optionally substituted with one of the substituent groups mentioned above.

The term “substantially” does not exclude “completely” e.g. a composition which is “substantially free” from Y may be completely free from Y. That is, the term “substantially” is to be interpreted as “completely” or “partially”. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DISCLOSURE OF OPTIONAL EMBODIMENTS

Exemplary, non-limiting embodiments of a magnetic body and a process for manufacturing the same will now be disclosed.

The magnetic body comprises an agglomeration of bonded rare earth magnetic particles characterized in that the magnetic body exhibits a maximum energy product loss (ΔBHmax) of about 12% or less as measured by ASTM 977/977M when subjected to a temperature of 180° C. for 1000 hours. The magnetic body may exhibit a maximum energy product loss (ΔBHmax) selected from the group consisting of less than about 11%, less than about 10%, less than about 9%, less than about 8%, less than about 7%, less than about 6%, less than about 5%, less than about 4%, less than about 3%, less than about 2%, and less than about 1%.

The magnetic body may have a remanence loss (ΔBᵣ) selected from the group consisting of less than about 1%, less than about 0.9%, less than about 0.8%, less than about 0.7%, less than about 0.6%, less than about 0.5%, less than about 0.4%, less than about 0.3%.

In the bonded rare earth magnetic body, the total surface area of the magnetic particles of the bonded magnetic body that may be substantially inert to oxidation may be selected from the group consisting of at least 70%, at least 75%, at least 80%, at least 85%, at least 90%, at least 95% and about 100%.

Due to the presence of the oxidation-inert magnetic particles in the bonded body, the surfaces of the magnetic particles within the magnetic body may be resistant to oxidation. When the magnetic particles form an agglomerate, the surfaces of the agglomerate may be resistant to oxidation.

The rare earth magnetic material particles may be comprised of an element selected from the group consisting of Neodymium, Praseodymium, Lanthanum, Cerium, Samarium, Yttrium, Iron, Cobalt, Zirconium, Niobium, Titanium, Chromium, Vanadium, Molybdenum, Tungsten, Hafnium, Aluminium, Manganese, Copper, Silicon, Boron and combinations thereof.

The rare earth magnetic material particles may have a composition, in atomic percentage, of the following formula:

(R₁₋ₐR′ₐ)ᵤFe_{100-u-v-w-x-y}CoᵥM_{w}TₓB_{y}

wherein

R is Nd, Pr, Didymium (a nature mixture of Nd and Pr at composition of Nd_{0.75}Pr_{0.25}), or a combination thereof;

R′ is La, Ce, Y, or a combination thereof;

M is one or more of Zr, Nb, Ti, Cr, V, Mo, W, and Hf; and

T is one or more of Al, Mn, Cu, and Si,

wherein 0.01=a=0.8, 7=u=13, 0.1=v=20, 0.01=w=1, 0.1=x=5, and 4=y=12.

The rare earth magnetic material particles may have a composition, in atomic percentage, of the following formula:

(MM₁₋ₐRₐ)ᵤFe_{100-u-v-w-x-y}YᵥM_{w}TₓB_{y}

wherein

MM is a mischmetal or a synthetic equivalent thereof;

R is Nd, Pr or a combination thereof;

Y is a transition metal other than Fe;

M is one or more of a metal selected from Groups 4 to 6 of the periodic table; and

T is one or more of an element other than B, selected from Groups 11 to 14 of the periodic table,

wherein 0=a<1, 7=u=13, 0=v=20, 0=w−5, 0=x=5 and 4=y=12.

The transition metal Y may be selected from Group 9 or Group 10 of the Periodic Table. Hence, Y may, be selected from one or more of Co, Rh, Ir, Mt, Ni, Pd, Pt and Ds. In one embodiment, the transition metal Y may be Co.

The metal M may be one or more of Zr, Nb, Ti, Cr, V, Mo, W, Rf, Ta, Db, Sg and Hf. In one embodiment, M is selected from Zr, Nb, or a combination thereof.

The element T may be one or more of Al, Cu, Ag, Au, Zn, Cd, Hg, Ga, In, Tl, Ge, Sn, Pb and Si. In one embodiment, T is Al.

In one embodiment, M is selected from Zr, Nb, or a combination thereof and T is selected from Al. In particular, M is Zr and T is Al.

The mischmetal or synthetic equivalent thereof may be a cerium-based mischmetal. The mischmetal or synthetic equivalent thereof may have the composition of 20% to 30% La, 2% to 8% Pr, 10% to 20% Nd and the remaining being Ce and any incidental impurities. The mischmetal or synthetic equivalent thereof has the composition of 25% to 27% La, 4% to 6% Pr, 14% to 16% Nd and 47% to 51% Ce.

The magnetic material particles may have a particle size in the range selected from the group consisting of about 1 micron to about 420 microns, about 1 micron to about 100 microns, about 1 micron to about 200 microns, about 1 micron to about 300 microns, about 100 micron to about 420 microns, about 200 micron to about 420 microns, about 300 micron to about 420 microns, about 1 micron to about 25 microns, about 1 micron to about 50 microns and about 1 micron to about 75 microns.

The magnetic particles in the magnetic body may exhibit a remanence (Br) value selected from the group consisting of about 7.5 kG to about 10.5 kG, about 8 kG to about 10.5 kG, about 8.5 kG to about 10.5 kG, about 9 kG to about 10.5 kG, about 9.5 kG to about 10.5 kG, about 10 kG to about 10.5 kG, about 7.5 kG to about 10 kG, about 7.5 kG to about 9.5 kG, about 7.5 kG to about 9 kG, about 7.5 kG to about 8.5 kG, and about 7.5 kG to about 8 kG, after being subjected to a temperature of 180° C. for 1000 hours.

The magnetic particles in the magnetic body may exhibit an intrinsic coercivity (Hci) value selected from the group consisting of about 6 kOe to about 12 kOe, about 6 kOe to about 7 kOe, about 6 kOe to about 8 kOe, about 6 kOe to about 9 kOe, about 6 kOe to about 10 kOe, about 6 kOe to about 11 kOe, about 11 kOe to about 12 kOe, about 10 kOe to about 12 kOe, about 9 kOe to about 12 kOe, about 8 kOe to about 12 kOe, and about 7 kOe to about 12 kOe, after being subjected to a temperature of 180° C. for 1000 hours.

During the manufacture of the magnetic body, an anti-oxidant may be in contact with the magnetic particles during or after the magnetic particles were subjected to compaction to form the magnetic body. The types of anti-oxidant that can be used are discussed further below.

There is also provided a bonded rare earth magnetic body comprising an agglomeration of bonded rare earth magnetic particles characterized in that the magnetic body exhibits lower maximum energy product loss (ΔBHmax) relative to a bonded magnetic body formed of particles coated with anti-oxidant prior to compact formation of said magnetic body.

A process of forming the above bonded rare earth magnetic body will now be disclosed.

The process comprises the steps of (a) compacting rare earth magnetic material particles to form said magnetic body; and (b) contacting a mobile phase comprising an anti-oxidant thereof through said magnetic body during or after said compacting step.

The compacting step can be undertaken via compression molding, injection molding or extrusion molding.

During compression molding, the magnetic material particles are placed into an open die or mould cavity.

The die or mould cavity is then closed with a cover or plug member and then subjected to high pressures and optionally high temperatures in order to promote the formation of a bonded magnetic body. The pressure used during compression molding may be selected from the range of about 98 MPa (1 ton/cm²) to about 1.96 GPa (20 tons/cm²). The temperature used during compression molding may be selected from the range of about −10° C. to about 600° C. Compression molding may include hot press molding (high pressures) or cold press molding (low pressures).

During injection molding, the magnetic particles and a polymeric binder are fed to a heating barrel to heat up and further mix the magnetic particles and polymeric binder. The molten mixture is then forced into a mold cavity, which is at a cold temperature. By forcing the molten mixture through the mold cavity, the magnetic particles and polymeric binder are compacted together and the molten mixture solidifies upon contact with the cold mold cavity in order to form a magnetic body according to the configuration of the mold cavity. Exemplary types of polymeric binders are as discussed further below.

In extrusion molding, the machine used to extrude materials is very similar to an injection moulding machine. In the extruder, a motor turns a screw which feeds the magnetic particles and a polymeric binder through a heater. The mixture melts into a molten composition which is forced through a die, forming a long ‘tube-like’ shape. The shape of the die determines the shape of the tube. The extrusion is then cooled and forms a solid shape. The tube may be printed upon, and cut at equal intervals. The pieces may be rolled for storage or packed together. Shapes that can result from extrusion include T-sections, U-sections, square sections, I-sections, L-sections and circular sections

The mobile phase may be introduced during or after compaction of the magnetic material particles to form the magnetic body.

By using a mobile phase comprising an anti-oxidant to contact with the exposed fresh surfaces that occur as the magnetic material particles break or fracture during compaction, at least 70% of the surfaces of the magnetic material particles may be passivated with the anti-oxidant during or after compaction. Hence, the passivated surfaces may be substantially inert to oxidation. In one embodiment, at least 75% of the surfaces may be passivated. In another embodiment, at least 80% of the surfaces may be passivated. In a further embodiment, at least 85% of the surfaces may be passivated. In yet a further embodiment, about 90% of the surfaces may be passivated. In yet a further embodiment, about 95% of the surfaces may be passivated. In yet a further embodiment, about 100% of the surfaces may be passivated.

The mobile phase may be contacted with the magnetic body during or after compaction with the aid of vacuum, compression force or capillary force.

The mobile phase may be selected from the group consisting of an aqueous solution containing an anti-oxidant as a solute such as phosphoric acid or precursors thereof, an organo-titanic coupling agent and carbon monoxide. The mobile phase may be a non-aqueous solution.

In one embodiment where phosphoric acid solution is used as the mobile phase, the magnetic material particles may be compacted in the presence of phosphoric acid solution. Phosphoric acid solution may be frozen into solid form and mixed with the magnetic material particles. During compaction, fresh surfaces that are exposed to the atmosphere may be formed when the magnetic material particles flakes or fragments as a result of the high pressure exerted on the magnetic material particles to form the magnetic body. As the frozen phosphoric acid melts and becomes solution, the solution is squeezed into the voids inside the magnetic body during compaction, which also anti-oxidates the exposed surfaces. Hence, in situ passivation occurs whereby the phosphoric acid passivate the fresh exposed surfaces in order to ensure that in the final magnetic body product, a substantially complete coverage of the surfaces of the magnetic material particles is obtained.

In another embodiment, the magnetic body that forms from the compaction of the magnetic material particles may be immersed in a solution of phosphoric acid. The bonded magnetic body is typically porous such that any air present in the pores may oxidize the exposed surfaces of the compacted magnetic material particles. A vacuum may be applied to the solution containing the magnetic body such that any air that may be present in the pores or cracks of the magnetic body is forced out from the magnet body so that the phosphoric acid solution can enter into the pores or cracks in order to passivate the surfaces of the magnetic material particles that may be exposed to the air in the pores. Hence, the phosphoric acid passivates the surfaces of the magnetic material particles when the magnetic body is dried. The vacuum may be applied for about 1 minute to about 10 minute and at a pressure of about 0.005 MPa to about 0.05 MPa. In one embodiment, the vacuum may be applied for about 5 minutes and at a pressure up to 0.05 MPa.

In an embodiment where an aqueous solution is used as the mobile phase, the aqueous solution may comprise an anti-oxidant as a solute that is dissolved in a suitable solvent. Exemplary anti-oxidants are discussed further below. The solvent may be an organic solvent. The organic solvent may be an alcohol having from 1 to 5 carbon atoms. The organic solvent may be a ketone having from 3 to 5 carbon atoms. Exemplary types of alcohol include methanol, ethanol, isopropanol, butanol or pentanol. Exemplary types of ketone include acetone, butanone or pentanone. The mobile phase may comprise water. The anti-oxidant present in the mobile phase may react with the magnetic material particles to form an anti-oxidant protective layer over the surfaces of the magnetic material particles. Due to the presence of the mobile phase and anti-oxidant, any fresh surfaces that were created during and after compaction due to the flaking or fragmentation of the magnetic material particles can be adequately passivated by the anti-oxidant. Hence, the anti-oxidant functions to substantially prevent the oxidation of the surfaces in the porous magnetic body so as to result in minimal ageing of the bonded magnetic body, even at an elevated temperature.

The mobile phase may be encapsulated by a capsule that is configured to rupture during compaction of the magnetic material particles. The capsules may be micro-sized and may be made from a material that can readily rupture under pressure during the compacting step in order to release the mobile phase contained therein. The capsules may be about 1 to about 1000 micron in length.

In another embodiment, the mobile phase may be introduced during or after compaction by flushing the magnetic material particles with the mobile phase.

During compaction, the mobile phase may be added to the magnetic particles in the form of superabsorbent polymer. The superabsorbent polymer may be added in a sufficient amount so that it is capable of absorbing a large quantity of mobile phase. In one embodiment, the superabsorbent polymer may be a cross-linked sodium polyacrylate that is commonly made from the polymerization of acrylic acid blended with sodium hydroxide in the presence of an initiator. In another embodiment, the superabsorbent polymer may be a polyacrylamide copolymer, an ethylene maleic anhydride copolymer, a cross-linked carboxy-methyl-cellulose, polyvinyl alcohol copolymers, a cross-linked polyethylene oxide or starch grafted copolymer of polyacrylonitrile.

The superabsorbent polymer and anti-oxidant may be mixed with the magnetic material particles in the homogeneous mixture. As the mixture is compacted, the pressure exerted during compaction forces the mobile phase out from the superabsorbent polymer such that the mobile phase fills the pores or voids in the magnetic body as it is being formed. In situ passivation is then achieved as the anti-oxidant present in the mobile phase passivates the fresh surfaces that are created as the magnetic material particles flakes or fragments under pressure.

After compaction, the magnetic body may be immersed into a mobile phase as described above. A vacuum may be applied to the mobile phase in order to force air out of the pores of the magnetic body. The vacuum may be applied for about 5 minutes and at a pressure up to 0.05 MPa. The escaping air is then replaced by the mobile phase which is introduced into the pores of the magnetic body. In this way, the mobile phase forms a protective layer over the internal surfaces of the magnetic material particles making up the magnetic body.

In one embodiment where the mobile phase is an organotitanates or organozinconates coupling agent, the organotitanates or organozinconates coupling agent may be admixed with the magnetic material particles before the compacting step. The organotitanates or organozinconates coupling agent may be of the following general form respectively:

(R′O)ₘ—Ti—(O—X—R²—Y)ₙ

or

(R′O)ₘ—Zr—(O—X—R²—Y)ₙ

where R′O is a monohydrolyzable group where R′ may be short or long chained alkyls (monoalkoxy) or unsaturated allyls (neoalkoxy); Ti or Zr is tetravalent titanium or zirconium atoms, respectively; X is a binder functional group such as phosphate, phosphito, pyrophosphato, sulfonyl, carboxyl, etc; R is a thermoplastic functional group such as: aliphatic and non-polar isopropyl, butyl, octyl, isostearoyl groups; napthenic and mildly polar dodecylbenzyl groups; or aromatic benzyl, cumyl phenyl groups; Y is a thermoset functional group that typically is reactive, e.g. amino or vinyl groups; and m and n represents the functionality of the molecule.

The type of the organotitanates or organozinconates coupling agent may be of six types, which is dependent on the value of “m” and “n”. The six different types of the organo-titanic coupling agent may be the monoalkoxy type (where m is 1 and n is 3), the coordinate type (where m is 4 and n is 2), the chelate type (where m is 1 and n is 2), the quat type (where m is 1 and n is 2 or 3), the neoalkoxy type (where m is 1 and n is 3) and the cycloheteroatom type (where m is 1 and n is 1).

The organo-titanic coupling agent may be selected from the group consisting of isopropyl dioleyl (dioctylphosphate) titanate, isopropyl tri(dioctylphosphate) titanate, isopropyl trioleyl titanate, isopropyl tristearyl titanate, isopropyl tri(dodecylbenzenesulfonate) titanate, isopropyl tri(dioctylpyrophosphate) titanate, di(dioctylpyrophosphato) ethylene titanate, tetraisopropyl di(dioctylphosphate) titanate and Neopentyl (dially)oxy tri(dioctyl)pyrophosphate titanate (LICA38™ from Kenrich Petrochemicals Inc. of Bayonne, N.J. of the United States of America).

During the compacting step, the pressure exerted during compaction forces the organo-titanic coupling agent to flow and contact with the fresh surfaces of the magnetic material particles within the magnetic body in order to form an anti-oxidative coating thereon.

The mobile phase may be carbon monoxide. The carbon monoxide may be introduced during or after the compacting step such that carbon monoxide can passivate the fresh surfaces that are created during compaction. Due to the passivation, the surfaces of the magnetic material particles within the magnetic body are less prone to oxidation.

Without being bound by theory, the inventors believe that carbon monoxide can act as a passivating agent due to the reaction that occurs on the surfaces of the magnetic material particles when placed in a heated carbon monoxide atmosphere. This surface reaction is believed to be as follows:

Nd₂Fe₁₄B(s)+CO(g)→FeₐC_{b}, Nd_{c}C_{d}, Nd₂Fe₁₄(B,C), FeₑO_{f}, Nd_{g}Oₕ(s)

The magnetic material particles may be mixed with an anti-oxidant thereof to form a substantially homogeneous mixture prior to the compacting step. The mixing can be carried out by liquid coating process, dry mixing or blending the magnetic powders with the anti-oxidant.

The anti-oxidant may be a phosphoric acid precursor. The phosphoric acid precursor may be phosphate ion donor. That is, the anti-oxidant can be any agent which allows phosphate ions to form a complex with the rare earth element.

A source of phosphate ions may be phosphate-containing compounds such as a metal phosphate complex. The metal phosphate complex may be selected from the group consisting of Group IA metals, Group IIA metals and Group IIIA metals. The metal phosphate complex may be selected from the group consisting of lithium phosphate, sodium phosphate, potassium phosphate, magnesium phosphate, calcium phosphate and aluminum phosphate. The phosphate-containing compounds may comprise an organic moiety therein. The organic moiety may comprise a carbonyl group having two amine moieties of the following formula R₁R₂N—C(═O)—NR₃R₄, wherein each of R₁, R₂, R₃ and R₄ is independently selected from the group consisting of hydrogen, C₁₋₂₀alkyl, C₃₋₁₀cycloalkyl, C₂₋₂₀alkenyl and aryl, or, alternatively, one of R₁ and R₂ and one of R₃ and R₄ are covalently linked therebetween to thereby form a heterocyclic ring. The organic moiety may be selected from the group consisting or urea, allantoin and hydantoin. In one embodiment, the organic moiety may be urea and hence the phosphate-containing compound may be urea-phosphate.

The anti-oxidant may be dissolved in a suitable organic solvent as discussed above. The anti-oxidant may be dissolved in an aqueous solvent such as water. The magnetic material particles are then added to the above solution. The solvent used is typically volatile and can be removed via evaporation from the solution via heating or stirring. As the solvent evaporates, the anti-oxidant re-solidifies from the solution and forms a substantially homogeneous mixture with the magnetic material particles. The re-solidified anti-oxidant may coat the magnetic material particles.

The magnetic material particles may be made from molten alloys of a desired composition. The molten alloys can be rapidly solidified into powders or flakes through conventional methods such as melt-spinning or jet-casting processes. In a melt-spinning or jet-casting process, the molten alloy mixture is flowed onto the surface of a rapidly spinning wheel. As the molten alloy mixture contacts the surface of the wheel, the molten alloy mixture rapidly forms ribbons, which then solidify into flake or platelet particles. The flake or platelet particles may then undergo compaction in order to form a bonded magnetic body.

During compaction, a number of additives may be added in order to enhance the compaction process or to improve the properties of the resultant magnetic body.

A binder may be added to the magnetic material particles to promote binding of the magnetic material particles during compaction in order to form the bonded magnetic body. The type of binders that can be used in a magnetic system to known to a person skilled in the art and may include epoxy resins, silicone resins, thermosetting polymers, thermoplastic polymers or elastomers that can function to hold the magnetic material particles together. An exemplary epoxy resin is epichlorohydrin/cresol novolac epoxy resin such as Epon™ Resin 164 from Hexoin Specialty Chemicals, Inc of Columbus, Ohio, United States of America. A thermosetting polymer may be a polymer that includes a phenol group such as phenol novolac resin or Bakelite. Exemplary thermoplastic polymers include nylon, polyethylene or polystyrene. An exemplary silicone binder is a silicone, hydroxyl-functional resin such as Dow Corning® 249 Flake Resin.

A curing agent may be added to promote the binding properties of the binder. When an epoxy resin is used as the binder, the curing agent may be an aliphatic amine, an aromatic amine or an anhydride. Other types of curing agents may include other catalytic or latent chemicals. An exemplary curing agent is a Dyhard 100 (Evonik Degussa of Essen of Germany).

A lubricant may be added to the magnetic material particles in order to substantially reduce the friction between the magnetic material particles and the die or mould cavity. The lubricant may aid to substantially minimize damage to the compression system due to friction forces. The bonded magnetic body obtained in this way may have a better quality in terms of appearance and density. An exemplary lubricant is zinc stearate. The use of a lubricant may be dependent on the type of mobile phase used. In one embodiment, if the mobile phase used is in the liquid phase, a lubricant may be optional, that is, a lubricant may or may not be necessary. In another embodiment, if the mobile phase used is in the gaseous phase, a lubricant may be necessary.

There is also provided a bonded rare earth magnetic body that is formed from the process comprising the steps of:

(a) compacting rare earth magnetic material particles to form said magnetic body; and

(b) contacting a mobile phase comprising an anti-oxidant thereof through said magnetic body during or after said compacting step.

There is also provided a magnetic body comprising an agglomeration of bonded rare earth magnetic particles, wherein the surfaces of said particles within said body are resistant to oxidation.

In one embodiment, the process may comprise the step of providing a sufficient amount of mobile phase relative to said rare earth magnetic material particles to form a bonded rare earth magnetic body, said bonded rare earth magnetic body exhibiting a maximum energy product loss (ΔBHmax) of 12% or less as measured by ASTM 977/977M when subjected to a temperature of 180° C. for 1000 hours. In one embodiment, the sufficient amount of mobile phase relative to the amount of said rare earth magnetic material particles may be at least about 0.3 wt %. The sufficient amount of said mobile phase relative to the amount of said rare earth magnetic material particles may be selected from the group consisting of at least about 0.5 wt %, at least about 0.7 wt %, at least about 0.9 wt %, at least about 1.0 wt %, at least about 1.2 wt %, at least about 1.4 wt %, at least about 1.6 wt %, at least about 1.8 wt % and at least about 2.0 wt %. Preferably, the sufficient amount of said rare earth magnetic material particles relative to said amount of said rare earth magnetic material particles may be at least about 1.0 wt %.

By providing a sufficient amount of mobile phase relative to said rare earth magnetic material particles, the bonded rare earth magnetic body formed may exhibit a maximum energy product loss (ΔBHmax) of 12% or less as measured by ASTM 977/977M when subjected to a temperature of 180° C. for 1000 hours. The magnetic body may exhibit a maximum energy product loss (ΔBHmax) selected from the group consisting of less than about 11%, less than about 10%, less than about 9%, less than about 8%, less than about 7%, less than about 6%, less than about 5%, less than about 4%, less than about 3%, less than about 2%, and less than about 1%.

### BRIEF DESCRIPTION OF DRAWINGS

The accompanying drawing illustrates a disclosed embodiment and serves to explain the principles of the disclosed embodiment. It is to be understood, however, that the drawing is designed for purposes of illustration only, and not as a definition of the limits of the invention.

FIG. 1 shows the permanent magnetic flux loss in percentage loss (%) at 275° C. for magnet formed from the present passivation process followed by backfill (as described in Example 1) and a magnet without backfilling (as described in Comparative Example 1).

FIG. 2 shows the permanent magnetic flux loss in percentage loss (%) at 200° C. for a magnet that was passivated using a mobile phase (as described in Example 2) and a magnet that was passivated in the absence of a mobile phase (as described in Comparative Example 2).

FIG. 3 shows the flux loss in percentage loss as a function of ageing time of five samples of MQ1-B3 magnetic bodies when aged at 180° C. for 1000 hours.

FIG. 4 shows the flux loss in percentage loss (%) as a function of ageing time of six samples of MQ1-F42 magnetic bodies when aged at 180° C. for 1000 hours.

FIG. 5A shows the B-H curve of a MQ1-B3 magnetic body that had not been passivated. FIG. 5B shows the B-H curve of a MQ1-B3 magnetic body that was formed by compacting MQ1-B3 magnetic particles that had been pre-coated with CO. FIG. 5C shows the B-H curve of a MQ1-B3 magnetic body that had been passivated using carbon monoxide for a duration of 1 hour. FIG. 5D shows the B-H curve of a MQ1-B3 magnetic body that had been passivated using carbon monoxide for a duration of 3 hours.

FIG. 6A shows the B-H curve of a MQ1-F42 magnetic body that had not been passivated. FIG. 6B shows the B-H curve of a MQ1-F42 magnetic body that was formed by compacting MQ1-F42 magnetic particles that were pre-coated with phosphoric acid. FIG. 6C shows the B-H curve of a MQ1-F42 magnetic body that had been passivated using carbon monoxide for a duration of 1 hour. FIG. 6D shows the B-H curve of a MQ1-F42 magnetic body that had been passivated using carbon monoxide for a duration of 2 hours.

FIG. 7A shows the total flux at 180° C. for six bonded magnet bodies formed from the present passivation process in the presence of a mobile phase (as described in Example 4 for magnet bodies “ISP+H₂O” and “binderless+H₂O”) and in the absence of a mobile phase which contains an anti-oxidant (as described in Comparative Example 3 for magnet bodies “MQLP”, “MQLP-AA4”, “MQLP-AA4+H₂O” and “ISP”).

FIG. 7B shows the permanent magnetic flux loss in percentage loss (%) at 180° C. for the same samples of FIG. 7A.

### EXAMPLES

In the following examples and comparative examples, unless stated otherwise, the magnetic material powder used was commercially available under the trade name MQP-B+, MQP-B3, MQP-14-12 and MQP-F42 from Magnequench, Inc. of Singapore. Aluminum phosphate and acetone were obtained from Sigma-Aldrich of St Louis, Mo. of the United States of America. 2-propanol was obtained from Fisher Scientific of Pittsburgh, Pa. of the United States of America. Epon™ Resin was obtained from Hexion of Columbus, Ohio of the United States of America. Dyhard 100S and Dyhard UR300 were obtained from Evonik Degussa of Essen of Germany.

### Example 1

2 grams of monobasic aluminum phosphate was dissolved in 20 ml of 2-propanol. 98 grams of magnetic material particles (MQP-B+) were then added into the above solution. The alcohol was then evaporated completely by a subsequent heating and mechanical stirring step, leaving 2 wt % of aluminum phosphate coated on the magnetic material particles. The coated magnetic material particles were compacted into a magnet under a pressure of 7 T/cm² without additional binders. The magnet was then immersed into water in a vacuum chamber. Vacuum up to 0.05 MPa was applied to facilitate water backfilling into the voids of the magnet. After the backfilling process, the magnet was blown dry at 275° C.

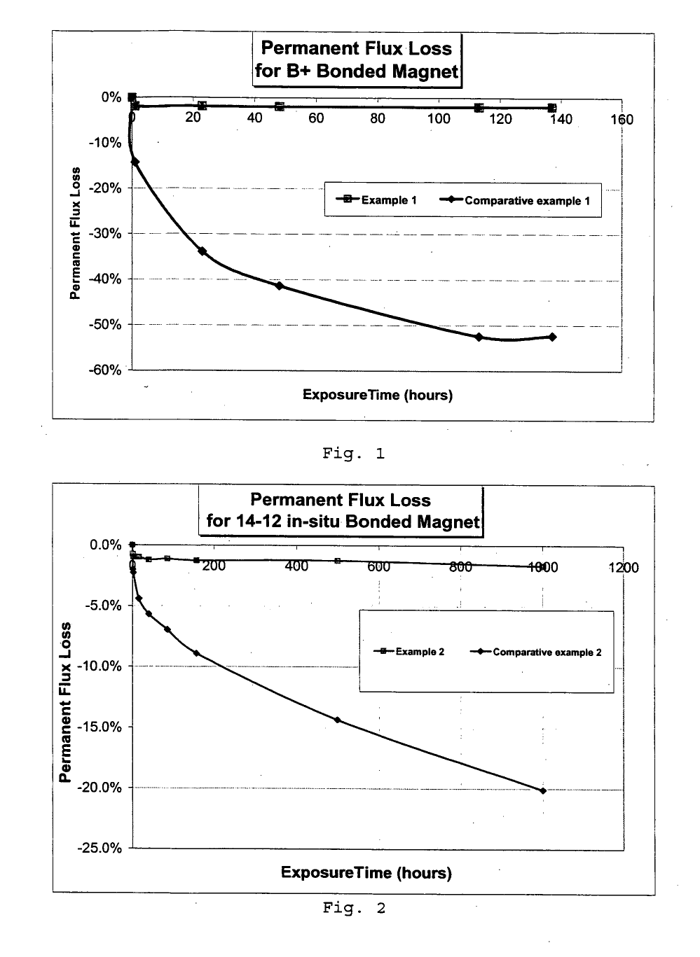

In order to determine the permanent flux loss of the magnetic body as a function of the exposure time, the magnetic body was aged in an oven. The result of this experiment is demonstrated in FIG. 1. After about 140 hours of exposure to ambient air at 275° C., the magnetic body made from this example suffered from 2% permanent magnetic flux loss.

### Example 2

2 grams of monobasic aluminum phosphate with binder compounds such as 1.57 grams of Epon™ Resin 164, 0.094 grams of Dyhard 100S, 0.034 grams of Dyhard UR300 and 0.029 grams of Zinc Stearate were dissolved in 30 ml of acetone. 96.27 grams of magnetic material particles (MQP-14-12) were then added into the above solution. The acetone was then evaporated completely by a subsequent heating and mechanical stirring step, leaving a mixture of aluminum phosphate and binder compound coated on the magnetic material particles. Before compaction, 1 wt % H₂O was added to these coated magnetic material particles and blended until a homogeneous mixture was obtained. Subsequently, these magnetic material particles were compacted to form a magnetic body under a pressure of 7 T/cm².

Due to the addition of water before the compaction step, the monobasic aluminum phosphate dissolved in the water to form a solution or mobile phase. During compaction, the mobile phase can flush and contact with the exposed fresh surfaces that occurred as the magnetic material particles broke or fractured due to the pressure used during compaction. Hence, in-situ passivation occurred during the compaction step as the mobile phase contacted the exposed fresh surfaces. By using a mobile phase that can move freely through the magnetic body, the fresh surfaces can be completely passivated so that the entire magnetic body can resist oxidation due to the presence of the protective anti-oxidant layer.

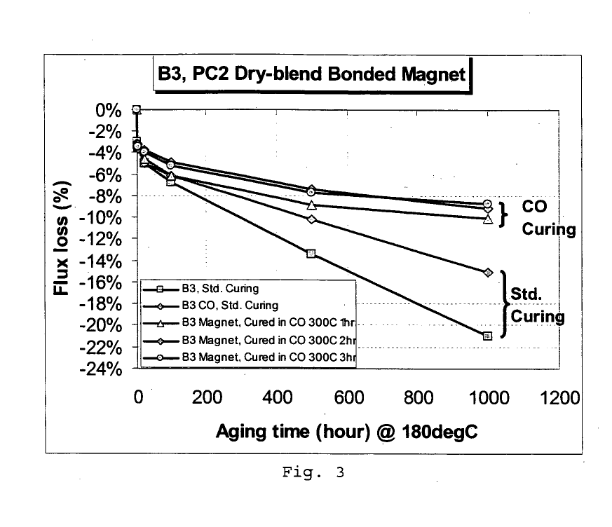

In order to determine the permanent flux loss of the magnetic body as a function of the exposure time, the magnetic body was cured in an oven set at 180° C. for 30 minutes. Following which, the ageing test was carried out in an oven set at 200° C. for a test time duration of 1000 hours. The result of this experiment is demonstrated in FIG. 2. After 1000 hours of exposure to ambient air at 200° C., the magnetic body made from this example suffered from 1.7% permanent magnetic flux loss.

This example illustrates the importance of the presence of mobile phase when passivating the fresh surfaces in the bonded magnets.

### Example 3

Two types of magnetic material particles used in this Example 3 were commercially available under the trade names MQ1-B3 and MQ1-F42 from Magnequench, Inc. of Singapore. The epoxy used here as the binder can be obtained commercially under the trade name STYCAT SE-617 Epoxy resin from Emerson & Cuming specialty polymers of Canton, Mass. of the United States of America.

2.8 grams of each of the two types of magnetic material particles were separately mixed with 2 wt % of epoxy (binder) and 0.1 wt % of zinc stearate (lubricant) to form separate homogenous mixtures. These resultant mixtures were separately compacted into separate magnetic bodies under a pressure of 7 T/cm². Each of the two magnetic bodies has a density of about 5.9 g/cc.

In order to passivate the magnetic bodies, the magnetic bodies were separately placed in a furnace containing carbon monoxide, which was maintained at a temperature of about 300° C. and at an atmospheric pressure of about 750 Torr. The magnetic bodies were placed in the furnace at different time durations of 0.5 hours, 1 hour, 2 hours and 3 hours.

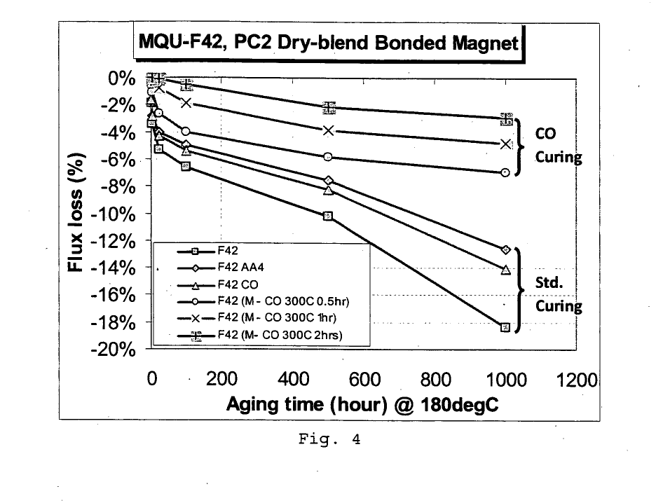

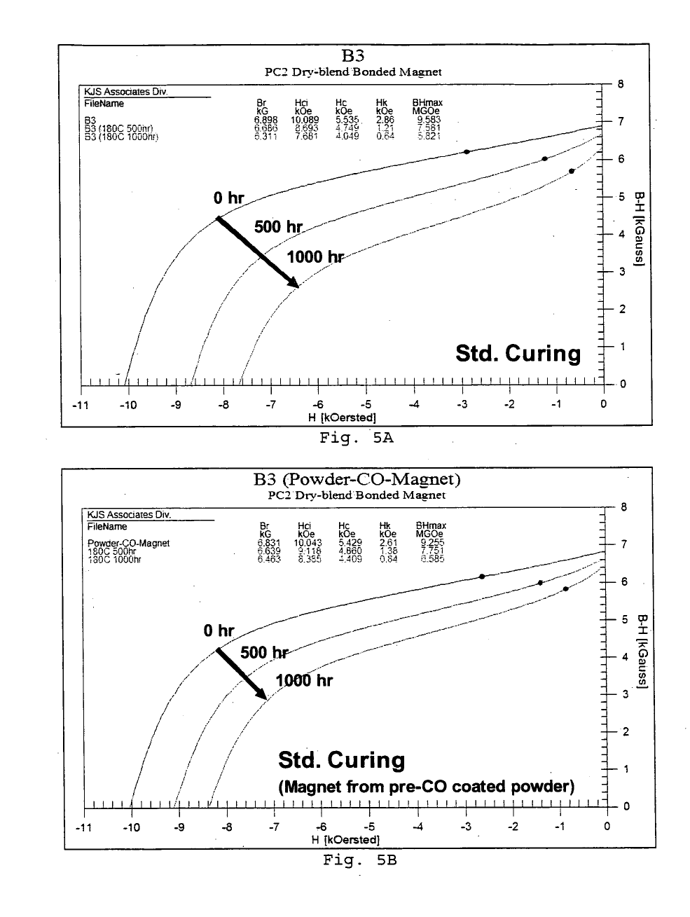

Following which, the ageing test was carried out in an oven set at 180° C. for a test time duration of 1000 hours. The results of the loss in flux as a function of ageing time for samples MQ1-B3 and MQ1-F42 are shown in FIGS. 3 and 4. In these figures, the flux loss of the MQ1-B3 or MQ1-F42 magnetic body that was not passivated using carbon monoxide (termed as “standard curing”) was also illustrated. For MQ1-B3, five samples of this type of magnetic body were investigated as seen in FIG. 3. Two samples, labeled as “B3, standard curing” and “B3 CO, standard curing”, were not passivated. The sample “B3, standard curing” refers to a magnetic body that was formed from compacting non-treated B3 magnetic powders, followed. by the ageing test mentioned above. The sample “B3 CO, standard curing” refers to a magnetic body that was formed from compacting pre-CO-coated magnetic powders, followed by the ageing test mentioned above. The remaining three samples, labeled respectively as “B3 Magnet, cured in CO 300C 1 hr”, “B3 Magnet, cured in CO 300C 2 hr” and “B3 Magnet, cured in CO 300C 3 hr”, were passivated using a carbon monoxide furnace at various time durations of 1 hour, 2 hours and 3 hours.

For MQ1-F42, six samples of this type of magnetic body were investigated as seen in FIG. 4. Three samples, labeled as “F42”, “F42 AA4” and “F42 CO”, were not passivated. The sample “F42” refers to a magnetic body that was formed from compacting non-treated F42 magnetic powders, followed by the ageing test mentioned above. The sample “F42 AA4” refers to a magnetic body that was formed from compacting magnetic powders pre-coated with phosphoric acid, followed by the ageing test mentioned above. The sample “F42 CO” refers to a magnetic body that was formed from compacting pre-CO-coated magnetic powders, followed by the ageing test mentioned above. The remaining three samples, labeled respectively as “F42 (M—CO 300C 0.5 hr)”, “F42 (M—CO 300C 1 hr)” and “F42 (M—CO 300C 2 hrs)” were passivated using a carbon monoxide furnace at various time durations of 0.5 hours, 1 hour and 2 hours.

The results of FIGS. 3 and 4 demonstrate that magnetic bodies that had been passivated using carbon monoxide have a lower percentage flux loss as compared to the corresponding magnetic bodies that had not been passivated using carbon monoxide. Hence, these results show that carbon monoxide can be used as a passivating agent and can protect the magnetic bodies from oxidation.

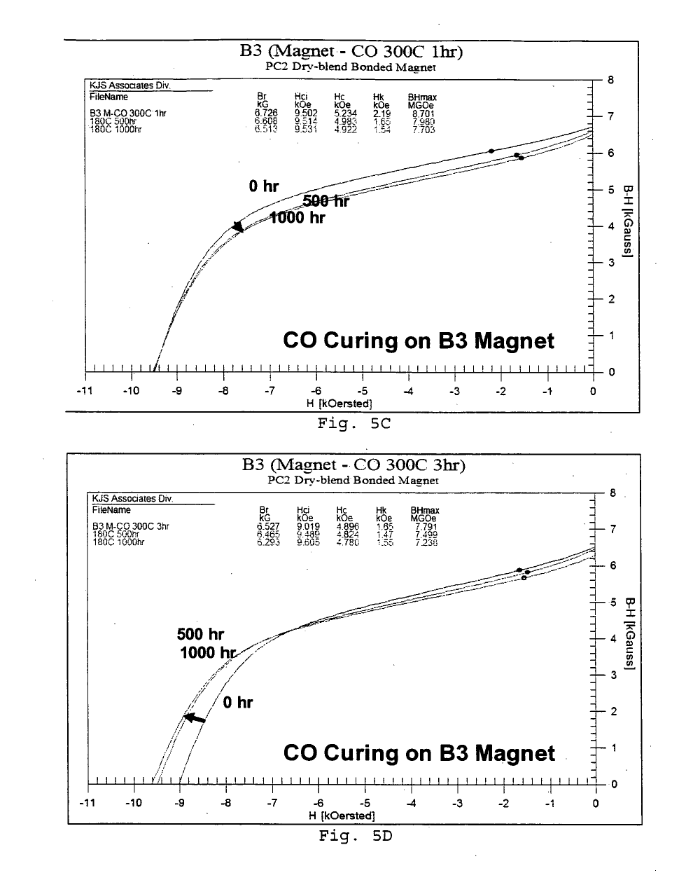

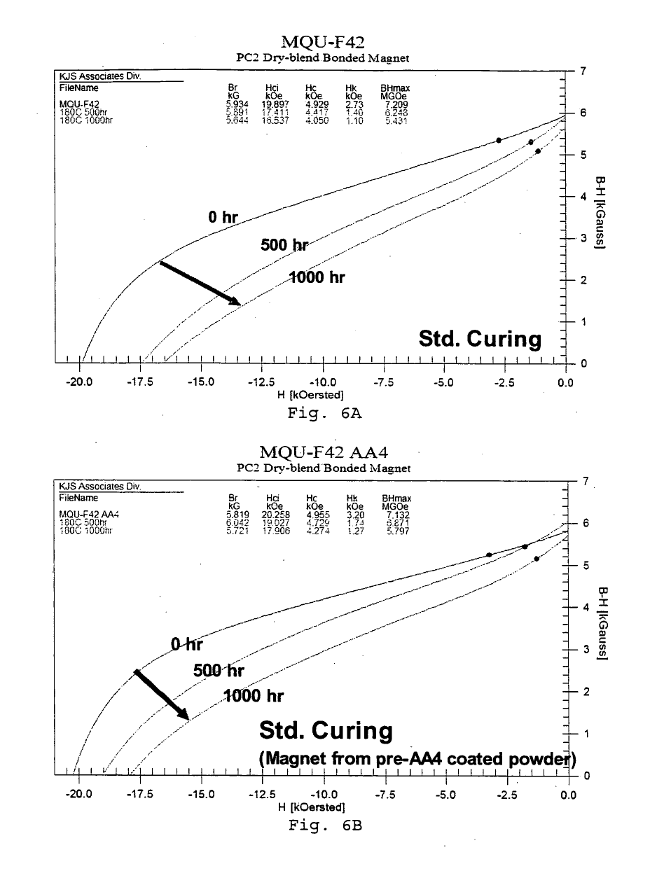

The properties of the passivated and non-passivated (“standard curing”) magnetic bodies made from MQ1-B3 and MQ1-F42 are shown in FIGS. 5A, 5B, 5C, 5D, 6A, 6B, 6C and 6D. FIG. 5A and FIG. 6A are B-H graphs of the MQ1-B3 and MQ1-F42 magnetic bodies, respectively, that had not been passivated using carbon monoxide. FIG. 5B and FIG. 6B are B-H graphs of the MQ1-B3 and MQ1-F42 magnetic bodies, respectively, that were formed from compacted magnetic particles that were pre-coated with CO (in FIG. 5B) and with phosphoric acid (in FIG. 6B). FIG. 5C and FIG. 6C are B-H graphs of the MQ1-B3 and MQ1-F42 magnetic bodies, respectively, that had been passivated using carbon monoxide for 1 hour. FIG. 5D is a B-H graph of the MQ1-B3 magnetic body that had been passivated using carbon monoxide for 3 hours. FIG. 6D is a B-H graph of the MQ1-F42 magnetic body that had been passivated using carbon monoxide for 2 hours. These figures show that the passivated magnetic bodies have a smaller percentage loss in the initial Br and Hci, as compared to the non-passivated magnetic bodies.

### Example 4

Two magnetic samples based on MQP-14-12 were prepared in this Example. The first sample contains Epon™ Resin 164 as a binder while the second sample does not contain Epon™ Resin 164.

In the first sample (hereinafter designated as “ISP+H₂O”), 1% by weight of dry monobasic aluminium phosphate was mixed with MQP-14-12 magnetic particles, which made up the rest of the mixture. The monobasic aluminium phosphate was dried by placing in a furnace at 120° C. for 4 hours. The hinder, Epon™ Resin 164, was prepared by dissolving 1.57 wt % Epon Resin 164, 0.094 wt % of Dyhard 100S and 0.034 wt % of Dyhard UR300 in acetone to form a binder solution. The magnetic mixture was added into the binder solution and mixed. During mixing, the acetone solvent was allowed to evaporate such that a mixture of aluminum phosphate and binder compound was coated on the magnetic material particles. Before compaction, 1 wt % H₂O was added to these coated magnetic material particles and blended until a homogeneous mixture was obtained. Subsequently, these magnetic material particles were compacted to form a magnetic body (termed as “PC2 bonded magnet”) under a pressure of 7 T/cm².

In the second sample (hereinafter designated as “binderless+H₂O”) , the same steps as above were repeated except that Epon™ Resin 164 was not added to the acetone solvent.

Due to the addition of water before the compaction step, the monobasic aluminum phosphate dissolved in the water to form a solution or mobile phase. During compaction, the mobile phase can flush and contact with the exposed fresh surfaces that occurred as the magnetic material particles broke or fractured due to the pressure used during compaction. Hence, in-situ passivation occurred during the compaction step as the mobile phase contacted the exposed fresh surfaces. By using a mobile phase that can move freely through the magnetic body, the fresh surfaces can be completely passivated so that the entire magnetic body can resist oxidation due to the presence of the protective anti-oxidant layer.

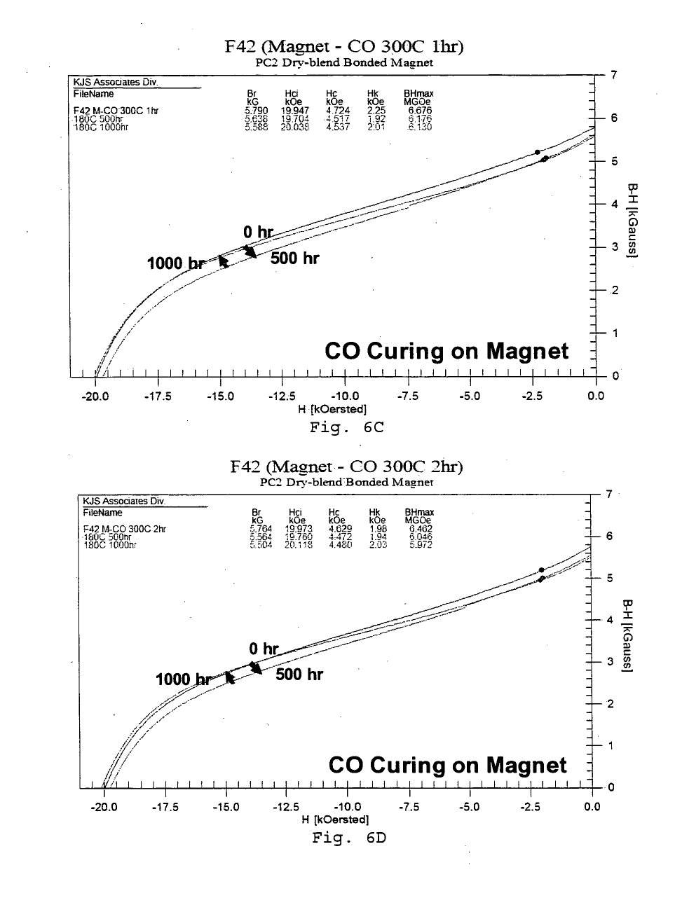

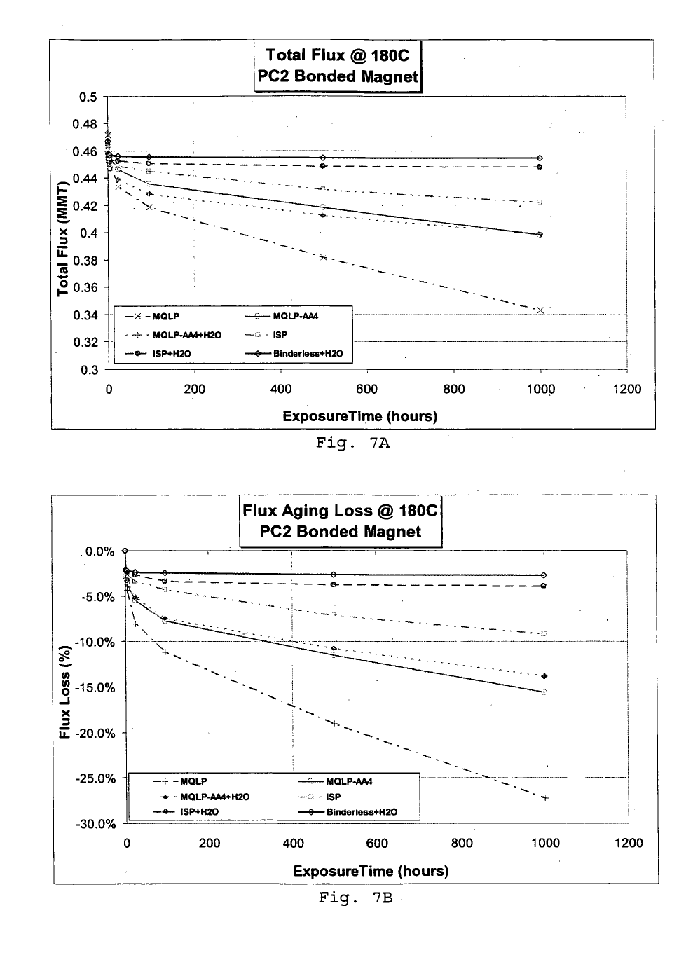

The two samples were then cured in an oven set at 180° C. for 30 minutes. Following which, an ageing test was carried out in an oven set at 180° C. for a test time duration of 1000 hours. The total flux graph of the various samples is shown in FIG. 7A and the flux loss graph of the various samples is shown in FIG. 7B (samples “MQLP”, “MQLP-AA4”, “MQLP-AA4+H₂O” and “ISP” are made according to the procedure set out in Comparative Example 3 further below). The flux loss, remanence values and BHₘₐₓ values are shown in Table 1 below. After 1000 hours of exposure to ambient air at 180° C., the sample “ISP₊H₂O” suffered from 3.87% permanent magnetic flux loss while the sample “binderless+H₂O” suffered from 2.69% permanent magnetic flux loss. The remanence loss of the sample “ISP+H₂O” was −0.34% while that of the sample “binderless+H₂O” was −2.23%. The maximum energy product loss of the sample “ISP+H₂O” was −1.89% while that of the sample “binderless+H₂O” was −3.92%.

TABLE 1

| | | Br (kG) | | | BHₘₐₓ (MGOe_{—} | | |
|---|---|---|---|---|---|---|---|
| | Flux | Before | After | Br | Before | After | BHₘₐₓ |
| Sample | Loss | ageing | ageing | loss | ageing | ageing | Loss |
| MQLP | 27.23% | 6.54 | 6.11 | −6.57% | 9.172 | 5.21 | −43.20% |
| MQLP-AA4 | 15.61% | 6.514 | 6.434 | −1.23% | 9.193 | 7.078 | −23.01% |
| MQLP-AA4- | 12.79% | 6.503 | 6.42 | −1.28% | 9.189 | 7.345 | −20.07% |
| H₂O | | | | | | | |
| ISP | 9.20% | 6.399 | 6.333 | −1.03% | 8.734 | 7.602 | −12.96% |
| ISP + H₂O | 3.87% | 6.411 | 6.389 | −0.34% | 8.932 | 8.763 | −1.89% |
| Binderless + | 2.69% | 6.533 | 6.387 | −2.23% | 9.259 | 8.896 | −3.92% |
| H₂O | | | | | | | |

This example illustrates the importance of the presence of the mobile phase when passivating the fresh surfaces in the bonded magnets.

### Comparative Example 1

The magnet was prepared under the same conditions of Example 1, but without the backfill step. Hence, the magnet was not immersed into water after compaction. Instead, the magnet was blown dry at 275° C. after the compaction step.

FIG. 1 shows the comparative permanent magnetic flux loss in percentage loss (%) for the magnet of. Example 1 and the magnet of Comparative Example 1. The magnet of Comparative Example 1 suffered from more than 50% of permanent magnetic flux loss after 100 hours of exposure to ambient air at 275° C. On the contrary, the magnet of Example 1 suffered only a 2% permanent magnetic flux loss.

Although both magnets are comprised of magnetic material particles mixed with anti-oxidant, only the magnet that had undergone backfill and hence, passivation, showed excellent anti-aging property. The results of FIG. 1 ascertains that the anti-oxidant present in the mobile phase can almost completely passivate existing surfaces of the magnetic material particles in the magnets as well as new surfaces created during or after magnet formation.

### Comparative Example 2

The experimental process of Example 2 is followed here, except that water was not added before the compaction step. Hence, the magnetic material particles, aluminum phosphate and binder compounds were compacted in the absence of a mobile phase. The formed magnetic body was subjected to curing and ageing steps as described in Example 2 and the results of the ageing test is also demonstrated in FIG. 2. As shown in FIG. 2, the magnetic body formed in this comparative example suffered more than 20% permanent magnetic flux. This is due to the absence of a mobile phase and hence, the anti-oxidant is not able to flow freely and contact with the exposed fresh surfaces generated during compaction. Hence, due to the significantly lesser extent of passivation of the fresh surfaces as compared to that of Example 2, the magnetic body of this comparative example suffers from a greater extent of oxidation, leading to a greater percentage loss in permanent magnetic flux.

### Comparative Example 3

Four samples were produced in this comparative example 3 using MQP-14-12 magnetic material particles.

The first sample (hereinafter designated as “MQLP”) was made by adding 1.59 wt % of Epon™ Resin 164 (based on the total weight of the Epon™ Resin 164 and the MQP-14-12 magnetic material particles) into 16 ml of acetone in a beaker. This solution was stirred until the Epon™ Resin 164 dissolved in the acetone. Following which, the MQP-14-12 powder was added to the beaker, which was then stirred under a temperature of 80° C. The effect of stirring under heat resulted in the evaporation of the acetone, leaving dried magnetic particles coated with the Epon™ Resin 164. The coated magnetic particles were kept in a dry state overnight by placing in a fume hood. Subsequently, these magnetic material particles were compacted to form a magnetic body (termed as “PC2 bonded magnet”) under a pressure of 7 T/cm².

The second sample (hereinafter designated as “MQLP-AA4”) was made in the same way as the first sample, except that the magnetic material particles were subjected to a pretreatment step with phosphoric acid. In the pretreatment step, 0.3 wt % of phosphoric acid was dissolved in 16 ml of acetone. Then 100 g of MQP-14-12 magnetic material particles were added to the solution and the acetone was evaporated by heating to 80° C. In the dried magnetic particles, the phosphoric acid formed a coating over the particles, which consisted of insoluble phosphate groups presented on the surfaces of the particles. These magnetic particles were then added to the Epon™ Resin 164-acetone solution as mentioned above and treated as mentioned above.

The third sample (hereinafter designated as “MQLP-AA4+H₂O”) was made in the same way as the second sample, except that the resultant magnetic material particles (which were coated with the insoluble phosphate groups and Epon™ Resin 164) were added to 1 wt % of H₂O before compaction. Although a mobile phase was present during compaction, the absence of an anti-oxidant in the mobile phase meant that in situ passivation could not be carried out. Although phosphate groups were present on the surfaces of the magnetic material particles, these groups were insoluble in the mobile phase and do not have any anti-oxidative effect. Hence, the resultant bonded magnet formed from this process suffered from oxidation problems and high flux loss.

The fourth sample (hereinafter designated as “ISP”) was formed by mixing 1% by weight of dry monobasic aluminium phosphate with MQP-14-12 magnetic particles, which made up the rest of the mixture. The monobasic aluminium phosphate was dried by placing in a furnace at 120° C. for 4 hours. The binder, Epon™ Resin 164, was prepared by dissolving 1.59% of Epon™ Resin 164 in acetone to form a binder solution. The magnetic mixture was added into the binder solution and mixed. During mixing, the acetone solvent was allowed to evaporate such that a mixture of aluminum phosphate and binder compound was coated on the dried magnetic material particles. Subsequently, these magnetic material particles were compacted to form a magnetic body (termed as “PC2 bonded magnet”) under a pressure of 7 T/cm².

The four samples were then cured in an oven set at 180° C. for 30 minutes. Following which, an ageing test was carried out in an oven set at 180° C. for a test time duration of 1000 hours. The total flux graph of the various samples is shown in FIG. 7A and the flux loss graph of the various samples is shown in FIG. 7B. The flux loss, remanence values and BHₘₐₓ values are shown in Table 1 above. After 1000 hours of exposure to ambient air at 180° C., the sample “MQLP” suffered from 27.23% permanent magnetic flux loss, sample “MQLP-AA4” suffered from 15.61% permanent magnetic flux loss, sample “MQLP-AA4-H₂O” suffered from 12.79% permanent magnetic flux loss, and sample “ISP” suffered from 9.20% permanent magnetic flux loss.

The remanence loss of the sample “MQLP” was −6.57%, sample “MQLP-AA4” was −1.23%, sample “MQLP-AA4-H₂O” was −1.28% while that of sample “ISP” was −1.03%.

The maximum energy product loss of the sample “MQLP” was −43.20%, sample “MQLP-AA4” was −23.01% sample-“MQLP-AA4-H₂O” was −20.07% while that of sample “ISP” was −12.96.

As can be seen from the higher losses in the various maximum energy product values of the samples of this Comparative Example 3 as compared to those in the samples in Example 4, the magnetic properties of these samples suffered a greater decrease over time as compared to those samples in Example 4.

### APPLICATIONS

It should be appreciated that the passivation technique disclosed herein is a simple yet effective method for improving the corrosion resistance and rust-inhibiting performance of rare earth magnetic material particles.

Advantageously, the disclosed in-situ passivation process, which comprises the mixing of anti-oxidants with magnetic material particles and optionally other additives in a mobile phase during or after magnet formation allows a protective anti-oxidative layer to be formed over the surfaces of the magnetic material particles making up the magnetic body. The magnetic body formed from the disclosed process may not suffer substantially from oxidation even at high temperatures. The magnetic body may not require a further surface coating or further physical or chemical treatment.

Advantageously, the passivation technique disclosed herein substantially reduces the susceptibility of rare earth magnetic material particles to oxidation under atmospheric as well as humid conditions by forming a protective layer over the surfaces of the magnetic material particles within the magnetic body. More advantageously, the formation of the protective layer occurs during or after compaction of the magnetic material particles. Even more advantageously, because the formation of the protective layer occurs during or after compaction, the anti-oxidant formed extends not only to existing surfaces of the magnetic material particles but also to newly created surfaces formed during compaction, thereby ensuring substantial complete coverage of the exposed surfaces.

Advantageously, the anti-oxidative property of the rare earth bonded magnets comprising magnetic material particles passivated by the process disclosed herein is comparable to that of sintered magnets. Even more advantageously, the enhanced anti-oxidative property of these magnets broadens the range of applications for polymer-bonded magnets. More advantageously, the disclosed bonded magnets display significantly improved ageing performance compared to magnets made of unpassivated magnetic material particles. Even more advantageously, the magnets passivated in the disclosed manner suffer minimal oxidation at high working temperatures even without any further surface coating steps and other physical or chemical treatments.

More advantageously, the passivation process disclosed herein does not involve any tuning of processing conditions, such as introduction of inert or non-oxidizing atmosphere and temperature control to maintain stability of the protective coat on the rare earth magnetic material particles. Even more advantageously, this passivation technique eliminates the need for complex equipment and improves the commercial and industrial viability of the manufacturing process without a decrease in productivity and increase in production cost.

The formed magnetic body may have minimal ageing loss at high working temperatures as compared to conventional magnets that are merely coated on the external surfaces. The presence of a protective layer on the surfaces of the magnetic material particles making up the magnetic body ensures that any surfaces that can be exposed to oxygen or air in the pores of the magnetic body are sufficiently oxidative-resistant. Since the opportunity for oxidation is substantially minimized, ageing of the magnetic body is substantially decreased until almost no ageing can be achieved.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A magnetic body comprising an agglomeration of bonded rare earth magnetic particles wherein said magnetic body exhibits a maximum energy product loss (ΔBHmax) of 12% or less as measured by ASTM 977/977M when subjected to a temperature of 180° C. for 1000 hours, and wherein an anti-oxidant is in contact with the magnetic particles during or after the magnetic particles were subjected to compaction to form the magnetic body.

2. The bonded rare earth magnetic body as claimed in claim 1, which exhibits a maximum energy product loss (ΔBHmax) of less than 10%.

3. The bonded rare earth magnetic body as claimed in claim 2, which exhibits a maximum energy product loss (ΔBHmax) of less than 5%.

4. The bonded rare earth magnetic body as claimed in claim 3, which exhibits a maximum energy product loss (ΔBHmax) of less than 4%.

5. The bonded rare earth magnetic body as claimed in claim 4, which exhibits a maximum energy product loss (ΔBHmax) of less than 2%.

6. The bonded rare earth magnetic body as claimed in claim 1, wherein said magnetic body exhibits a remanence loss (ΔB_{R}) of 1% or less as measured by ASTM 977/977M when subjected to a temperature of 180° C. for 1000 hours.

7. The bonded rare earth magnetic body as claimed in claim 6, wherein the remanence loss (ΔBᵣ) is less than 0.5%.

8. The bonded rare earth magnetic body as claimed in claim 7, wherein the remanence loss (ΔBᵣ) is less than 0.4%.

9. The bonded rare earth magnetic body as claimed in claim 1, wherein at least 70% of the total surface area of the magnetic particles of said bonded magnet is substantially inert to oxidation.

10. The bonded rare earth magnetic body as claimed in claim 9, wherein at least 95% of the total surface area of the magnetic particles of said bonded magnet is substantially inert to oxidation.

11. The magnetic body as claimed in claim 10, comprising an agglomeration of bonded rare earth magnetic particles, wherein the surfaces of said particles within said body are resistant to oxidation.

12. The magnetic body as claimed in claim 1, wherein said rare earth magnetic material particles are comprised of an element selected from the group consisting of Neodymium, Praseodymium, Lanthanum, Cerium, Samarium and combinations thereof.

13. The magnetic body as claimed in claim 1, wherein said rare earth magnetic material particles have the composition, in atomic percentage, of:
(R₁₋ₐR′ₐ)ᵤFe_{100-u-v-w-x-y}CoᵥM_{w}TₓB_{y}
wherein
R is Nd, Pr, Didymium (a nature mixture of Nd and Pr at composition of Nd_{0.75}Pr_{0.25}), or a combination thereof;
R′ is La, Ce, Y, or a combination thereof;
M is one or more of Zr, Nb, Ti, Cr, V, Mo, W, and Hf; and
T is one or more of Al, Mn, Cu, and Si,
wherein 0.01≦a≦0.8, 7≦u≦13, 0.1≦v≦20, 0.01≦w≦1, 0.1≦x≦5, and 4≦y≦12.

14. The magnetic body as claimed in claim 1, wherein said rare earth magnetic material particles have the composition, in atomic percentage, of:
(MM₁₋ₐRₐ)ᵤFe_{100-u-v-w-x-y}YᵥM_{w}TₓB_{y}
wherein
MM is a mischmetal or a synthetic equivalent thereof;
R is Nd, Pr or a combination thereof;
Y is a transition metal other than Fe;
M is one or more of a metal selected from Groups 4 to 6 of the periodic table; and
T is one or more of an element other than B, selected from Groups 11 to 14 of the periodic table,
wherein 0≦a<1, 7≦u≦13, 0≦v≦20, 0≦w≦5; 0≦x≦5 and 4≦y≦12.

15. The magnetic body as claimed in claim 14, wherein the mischmetal is a cerium-based mischmetal.

16. The magnetic body as claimed in claim 14, wherein said mischmetal or synthetic equivalent thereof has the following composition in weight percent:
20% to 30% La;
2% to 8% Pr;
10% to 20% Nd; and
the remainder being Ce and any incidental impurities.

17. The magnetic body as claimed in claim 16, wherein said mischmetal or synthetic equivalent thereof has the following composition in weight percent:
25% to 27% La;
4% to 6% Pr;
14% to 16% Nd; and
47% to 51% Ce.

18. The magnetic body as claimed in claim 1, wherein magnetic particles exhibit a remanence (Bᵣ) value of from 7.5 kG to 10.5 kG after being subjected to a temperature of 180° C. for 1000 hours.

19. The magnetic body as claimed in claim 1, wherein magnetic particles exhibit an intrinsic coercivity (H_{ci}) value of from 6 kOe to 12 kOe after being subjected to a temperature of 180° C. for 1000 hours.

20. The magnetic body as claimed in claim 1, wherein an anti-oxidant is in contact with the magnetic particles during or after the magnetic particles were subjected to compaction to form the magnetic body.

21. A bonded rare earth magnetic body comprising an agglomeration of bonded rare earth magnetic particles, wherein an anti-oxidant is in contact with the magnetic particles during or after the magnetic particles were subjected to compaction to form the magnetic body and wherein said magnetic body exhibits lower maximum energy product loss (ΔBHmax) relative to a bonded magnetic body formed of particles coated with anti-oxidant prior to compact formation of said bonded magnetic body.

22.-41. (canceled)
